(19) United States
(12) Patent Application Publication
(10) Pub. No.: US 2025/0292298 A1
(43) Pub. Date: Sep. 18, 2025

(54) CONTEXT-AWARE PERSONALIZATION AND MULTI-FUNCTIONAL SERVICE DELIVERY IN VEHICLE SYSTEMS

(71) Applicant: Applied Electric Vehicles Ltd, Scores by VIC (AU)

(72) Inventors: Marc Alexander, Croydon Hills (AU); Aleks Witko, Mont Albert (AU)

(73) Assignee: Applied Electric Vehicles Ltd, Scores by VIC (AU)

(21) Appl. No.: 18/606,383

(22) Filed: Mar. 15, 2024

(51) Int. Cl. G06Q 30/06; G06F 3/01; G06F 3/16; G06F 21/31; G06V 20/56; G06V 40/16; G06V 40/20; H04L 67/306

(52) U.S. Cl. CPC G06Q 30/06; G06F 3/017; G06F 3/167; G06F 21/31; G06V 20/56; G06V 40/175; G06V 40/20; H04L 67/306

(57) ABSTRACT

Context-aware personalization and multi-functional service delivery in vehicle systems is described. In one or more implementations, a vehicle system can collect, by one or more sensors, input data associated with a proximal space at least partially surrounding a vehicle. The vehicle system can collect contextual data. The vehicle system can integrate the input data with the contextual data to contextualize an event occurring within the proximal space. The vehicle system can determine, based on the integrated data, an intent associated with the event. The vehicle system can determine an interaction to satisfy the intent.

### BACKGROUND

As autonomous vehicles become increasingly integrated into daily life, there is a growing need for more intuitive and seamless methods for users to interact with these vehicles, especially regarding the acquisition of goods and services and other interactions. Traditional interfaces, reliant on screen-based inputs and complex navigation menus, pose significant accessibility and usability challenges. There exists a need for an innovative approach that simplifies the interaction process, enhances security, and personalizes the user experience.

### BRIEF DESCRIPTION OF THE DRAWINGS

FIG. 1 is a block diagram of a non-limiting example operating environment including a vehicle having a vehicle system configured to provide context-aware personalization and multi-functional service delivery to a user within a proximal space at least partially surrounding the vehicle.

FIG. 2 is a block diagram of a non-limiting example of a vehicle system of an autonomous vehicle that provides an enhanced user experience through personalization and intent recognition.

FIG. 3 depicts a procedure to provide a seamless, personalized user experience with an autonomous vehicle system.

FIG. 4 depicts a procedure implementing a user recognition algorithm via a user recognition module to recognize a user within a proximal space at least partially surrounding a vehicle.

FIG. 5 depicts a procedure implementing an intent recognition algorithm via an intent recognition module to recognize an intent of a user.

FIG. 6 depicts a procedure implementing an interaction algorithm via an interaction module to translate insights gained from the intent recognition module into one or more interactions.

FIG. 7 depicts a procedure implementing a user profile algorithm via a user profile module to create and update user profiles.

FIG. 8 depicts a procedure implementing a security and authentication algorithm via a security and authentication module to safeguard user data, ensure secure interactions, and manage access controls.

### DETAILED DESCRIPTION

Conventional web and application screen interfaces rely heavily on complex menus and e-commerce interfaces, which can be daunting for users across different age groups and technological proficiency levels. The proposed techniques remove or significantly reduce reliance on these interfaces, aiming to broaden accessibility and usability. By simplifying user interactions, the proposed techniques make the services provided by autonomous vehicles more accessible to a wider range of customers, including those with limited technological skills or familiarity with digital interfaces.

Conventional methods of user authentication and access control often require manual inputs, which can be cumbersome and less secure. The proposed techniques incorporate inherent user authentication and access control mechanisms, facilitating seamless and secure transactions and access to restricted goods or services. Conventional systems lack the capability to personalize the user experience based on individual preferences, history, or contextual knowledge. The proposed techniques enhance the user experience by predicting user needs and customizing the vehicle's “personality” and presentation accordingly. The proposed techniques provide a transformative approach to user interaction with autonomous vehicles, focusing on simplification, security, and personalization to address the limitations of current interfaces and interaction models.

An autonomous vehicle system for context-aware personalization and multi-functional service delivery is described. This system integrates advanced sensor technologies and sophisticated deep learning algorithms to deliver services that are both personalized and highly attuned to the contextual nuances of the user environment. This is configured to accurately recognize users along with their specific intentions, thereby enabling the activation of bespoke features tailored to the user's immediate context. This system is versatile, allowing adept responses to a diverse array of scenarios.

In one or more implementations, the autonomous vehicle system includes a sensor array that is repurposed (e.g., originally intended for navigation purposes) to now facilitate the activation of various vehicle functionalities directly aligned with the user's situational context. This repurposing extends the utility of the autonomous vehicle beyond traditional expectations, enabling it to function dynamically as a mobile commercial outlet, an on-demand healthcare provider, or an urban sanitation solution, among other roles.

In some aspects, the techniques described herein relate to a method including collecting, by one or more sensors of a vehicle system, input data associated with a proximal space at least partially surrounding a vehicle, collecting, by the vehicle system, contextual data, integrating, by the vehicle system, the input data with the contextual data to contextualize an event occurring within the proximal space, determining, by the vehicle system, based on the integrated data, an intent associated with the event, and determining, by the vehicle system, an interaction to satisfy the intent.

In some aspects, the techniques described herein relate to a method, wherein the input data indicates an immediate action, a behavior, or a verbal command provided by a user within the proximal space.

In some aspects, the techniques described herein relate to a method, wherein the contextual data includes a geographical position of the user, a time-related factor, an environmental condition, a presence of a person, or a presence of an object.

In some aspects, the techniques described herein relate to a method, wherein the intent is associated with the user procuring a good or a service from the vehicle.

In some aspects, the techniques described herein relate to a method, further including authenticating, by the vehicle system, a user for the interaction.

In some aspects, the techniques described herein relate to a method, further including performing, by the vehicle system, the interaction with a user.

In some aspects, the techniques described herein relate to a method, wherein performing the interaction with the user includes actuating one or more subsystems of the vehicle.

In some aspects, the techniques described herein relate to a system including a processor, a user recognition module executable by the processor to recognize a user within a proximal space at least partially surrounding a vehicle, an intent recognition module executable by the processor to infer an intent of the user, and an interaction module executable by the processor to interpret the intent of the user, determine an interaction to satisfy the intent, and execute the interaction.

In some aspects, the techniques described herein relate to a system, further including a user profile module executable by the processor to create a user profile for the user, aggregate data from at least the interaction, and update the user profile based on the aggregated data.

In some aspects, the techniques described herein relate to a system, further including a security and authentication module executable by the processor to encrypt and store user data associated with the user, continuously monitor for an authentication cue when the user interacts with the vehicle, responsive to the authentication cue, authenticate the user via one or more secure authentication methods, continuously monitor for an unusual or unauthorized access attempt, and responsive to detecting the unusual or unauthorized access attempt, initiate a security response.

In some aspects, the techniques described herein relate to a system, wherein the user recognition module recognizes the user within the proximal space at least partially surrounding the vehicle via one or more sensor devices.

In some aspects, the techniques described herein relate to a system, wherein the intent recognition module infers the intent of the user based on data collected from the one or more sensor devices.

In some aspects, the techniques described herein relate to a system, wherein the intent recognition module infers the intent of the user based on contextual data.

In some aspects, the techniques described herein relate to a system, wherein the intent recognition module infers a plurality of intents including the intent.

In some aspects, the techniques described herein relate to a system, wherein the intent recognition module categorizes and prioritizes the plurality of intents.

In some aspects, the techniques described herein relate to a system, wherein the interaction module determines the interaction to satisfy the intent based on a response strategy.

In some aspects, the techniques described herein relate to a computer-readable storage medium having instructions stored thereon that, when executed by a processor, cause the processor to perform operations including collecting, by one or more sensors, input data associated with a proximal space at least partially surrounding a vehicle, collecting contextual data, integrating the input data with the contextual data to contextualize an event occurring within the proximal space, determining, based on the integrated data, an intent associated with the event, and determining an interaction to satisfy the intent.

In some aspects, the techniques described herein relate to a computer-readable storage medium, wherein the input data indicates an immediate action, a behavior, or a verbal command provided by a user within the proximal space.

In some aspects, the techniques described herein relate to a computer-readable storage medium, wherein the contextual data includes a geographical position of the user, a time-related factor, an environmental condition, a presence of a person, or a presence of an object.

In some aspects, the techniques described herein relate to a computer-readable storage medium, wherein the intent is associated with the user procuring a good or a service from the vehicle, and the interaction includes actuating a subsystem of the vehicle to allow the user to procure the good or the service from the vehicle.

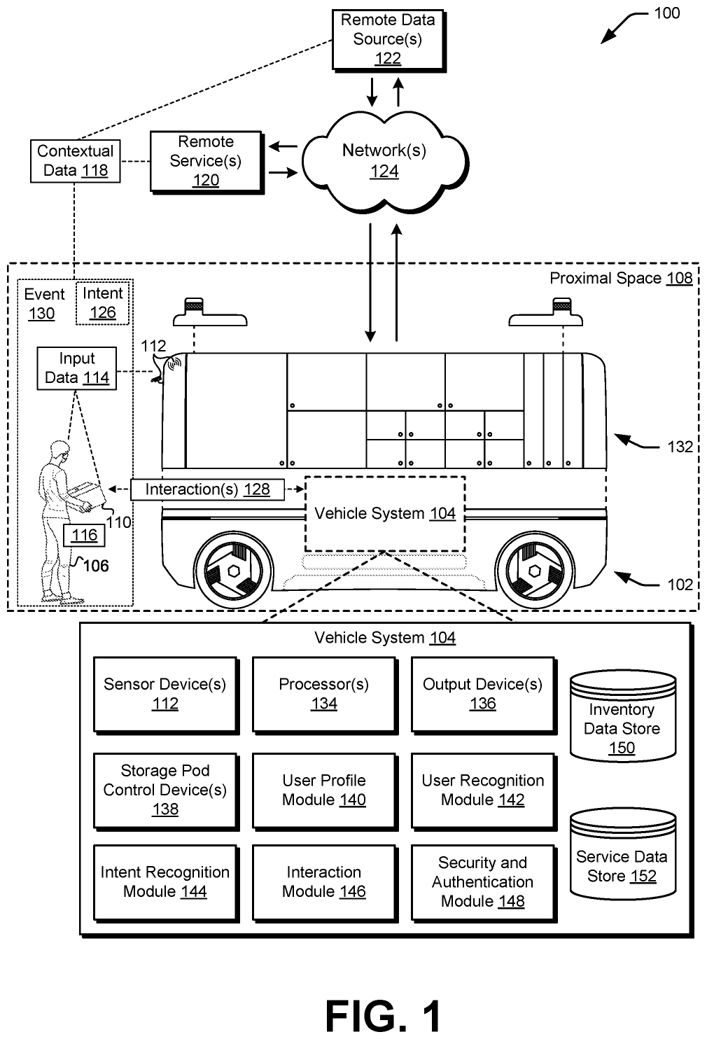

FIG. 1 is a block diagram of a non-limiting example operating environment 100 including a vehicle 102 having a vehicle system 104 configured to provide context-aware personalization and multi-functional service delivery to a user 106 within a proximal space 108 at least partially surrounding the vehicle 102. The vehicle 102 may be any type of autonomous vehicle including ground vehicles (e.g., trucks, cars, vans, tractor-trailers, tanks), air vehicles, rail vehicles, marine vehicles, space vehicles, or other vehicle types. The vehicle 102 in at least one example is completely unmanned (e.g., autonomously controlled, remotely controlled). In at least one other example, the vehicle 102 is at least partially controlled by manual inputs (e.g., semi-autonomously controlled, at least partially operated by the user 106). In at least one example, the vehicle 102 includes a passenger compartment and is operable to transport occupants. In at least one other example, the vehicle 102 is configured for transporting cargo alone, and does not include a passenger compartment. Although the vehicle 102 is described as having mobility, the vehicle 102 can operate in a parked mode, a sentry mode, or other stationary mode. In some implementations, the propulsion system of the vehicle 102 is disabled while the vehicle 102 is stationary and cannot be enabled until the vehicle 102 has completed its mission.

The proximal space 108 is an immediate surrounding area within which the vehicle system 104 can detect, recognize, and interact with objects, obstacles, and individuals. In the illustrated example, the user 106 is carrying a package 110, and the vehicle system 104 is configured to detect the user 106 and the package 110 via one or more sensor devices 112 and collect input data 114. The input data 114 is or includes the raw, direct information collected from various sources that indicates a user's immediate actions, behaviors, or verbal commands. This includes data gathered through voice recognition (e.g., capturing spoken commands or queries), analysis of body movements and positioning (e.g., using the sensor device(s) 112 to detect gestures or proximity to the vehicle 102), facial expressions (e.g., utilizing facial recognition technology), and signals from proximal network devices 116 (e.g., smartphones or wearables). The input data 114 provides the vehicle system 104 with primary indicators of the user's 106 potential needs or desires.

In addition to the input data 114, the vehicle system 104 is configured to collect contextual data 118. The contextual data 118 can be or can include a geographical position of the user 106, which can influence the relevance of information or services provided by the vehicle system 104. The contextual data 118 can be or can include time-related factors, including time of day, day of the week, and season, which can affect the needs and preferences of the user 106. The contextual data 118 can be or can include environmental conditions surrounding the user 106, such as weather, temperature, and ambient noise, which may impact the responses and suggestions provided by the vehicle system 104. The contextual data 118 can be or can include the presence of other people, the user's activities (e.g., working, leisure), and social settings. The contextual data 118 includes additional information that, when combined with the input data 114, provides a richer understanding of the user's 106 situation or environment. The contextual data 118 helps the vehicle system 104 to interpret the input data 114 within the framework of the user's 106 current circumstances, enhancing the accuracy of an intent 126 prediction.

The intent 126 represents the underlying purpose or goal behind a user's 106 actions or commands as interpreted by the vehicle system 104. The intent 126 is what the user 106 aims to achieve through their interaction(s) 128 with the vehicle 102, such as obtaining information, requesting a service, expressing a desire for a particular good, or signaling a need that the vehicle 102 can fulfill. Understanding the intent 126 allows the vehicle system 104 to accurately predict and provide the most relevant and personalized responses or services to the user 106 as part of the interaction 128.

The intent 126 can be or can include informational intent, transactional intent, navigational intent, interactional intent, any combination thereof, and/or the like. Information intent, for instance, is when the user 106 seeks information, such as news updates, weather forecasts, or educational content. Transactional intent, for instance, is when the user 106 wants to perform a transaction, such as making a purchase, booking a service, or transferring funds. Navigational intent, for instance, is when the user 106 needs to find an item or service offered by the vehicle 102 (e.g., where the package 110 should be dropped off). Interactional intent, for instance, is when the user 106 wishes to interact the vehicle system 104 in some manner.

The interaction(s) 128 encompasses the dynamic exchange between the user 106 and the vehicle 102. The interaction(s) 128 can manifest as direct commands from the user 106, responses provided by the vehicle 102, personalized service offerings based on predicted needs, or any engagement involving the vehicle 102 and the user 106. The interaction(s) 128 is shaped by the predictions made by the vehicle system 104 and the responses provided by the user 106, forming a continuous loop of communication and service provision.

The interaction(s) 128 can be or can include direct commands that the user 106 explicitly tells the vehicle system 104 what action to perform. The interaction(s) 128 can be or can include conversational interactions that represent more natural, dialogue-based exchanges where the user 106 and the vehicle system 104 communicate based and forth, allowing for clarification and adaptation, in addition to refining future interactions between the user 106 and the vehicle system 104. The interaction(s) 128 can be or can include predictive actions, where the vehicle system 104 anticipates the user's 106 needs based on context, data, and past behavior, suggesting actions or information without a direct command. The interaction(s) 128 can include automated services, where the vehicle system 104 autonomously performs tasks or services based on predetermined conditions or schedules, without needing real-time input from the user 106.

In the illustrated example, collecting the input data 114 and the contextual data 118, determining the intent 126 of the user 106, and facilitating the interaction(s) 128 between the user 106 and the vehicle 102 are triggered, at least in part, by an event 130. The event 130, in this context, is or includes any occurrence or action detected by the vehicle system 104 (e.g., via the sensor(s) 112) that triggers a response or requires analysis. The event 130 can range from the user 106 approaching the vehicle 102, initiating a verbal command, exhibiting a particular facial expression and/or body language, or any action that the vehicle system 104 can detect and to which the vehicle 102 might need to respond. In one or more implementations, the event 130 acts as the catalyst for the predictive and responsive capabilities of the vehicle system 104, initiating the process of intent recognition and service provision.

In one or more implementations, the proximal space 108 is dynamically defined by the range and capabilities of the vehicle system 104, such as by the sensor(s) 112. More generally, the proximal space 108 is any setting where the vehicle 102 may park, at least temporarily, such as a side of roadway, a driveway, a garage, a carport, a parking lot, an off road area (e.g., a construction site, a mining operation, a recreational area), to name a few, including public or private spaces. In some instances, the proximal space 108 is in a place that provides convenient access to the user 106. For example, the proximal space 108 is a driveway, alley, garage, shed, carport, lot, yard, or any other location within a short walking distance to a residential property (e.g., a house, an apartment) where the user 106 lives. In another example, the proximal space 108 is near a non-residential property (e.g., business, construction or mining site, school, place of worship) where the user 106 works or spends their day.

The vehicle 102 can provide the user 106 with access to items and/or services that may be purchased, consumed, or otherwise utilized by the user 106 as part of the interaction(s) 128. The vehicle 102, in one example, is configured as a last mile or end point aggregator for a range of items and/or services that help the user 106 complete their work and/or other daily tasks. In this context, the vehicle 102 includes one or more storage pods 132. The storage pods 132 are compartments, bays, drawers, shelves, containers, or other partially enclosed or fully enclosed portion of the vehicle 102 that is used to facilitate the exchange of items or performance of services, such as part of the interaction(s) 128. As one example, the storage pods 132 include a waste disposal pod where the user 106 disposes trash and recyclables. The storage pods 132 can include refrigerated compartments for preserving perishable items (e.g., groceries, medicines, flowers, beverages). The storage pods 132 may include non-refrigerated bays that contain non-perishable items (e.g., paper products, non-perishable food items, materials, supplies). In one or more examples, the storage pods 132 are configured as tool chests for hand tools, power tools, building materials, and the like. In at least one example, the storage pods 132 include a logistics pod for handling inbound and outbound delivery of mail, packages, and other deliverable items. Many other types of the storage pods 132 exist.

To implement the techniques for context-aware personalization and multi-functional service delivery, the vehicle 102 relies on various components of the vehicle system 104. The vehicle system 104 generally includes multiple electronic systems configured to interface with electro-mechanical components of the vehicle 102 to implement processor-based vehicle functions and processor-driven operations, such as for driving or maneuvering the vehicle 102 in the operating environment 100, facilitating the interaction(s) 128 (e.g., providing access to items or services associated with the storage pods 132), and the like. For example, the electronic components of the vehicle system 104 configure the vehicle 102 to automate functions in furtherance of implementing context-aware personalization and multi-functional service delivery. As one example, the vehicle system 104 controls access to the storage pods 132 to allow the user 106 to securely retrieve and/or purchase items within the proximal space 108, as if the vehicle 102 is a personal store or extension of their kitchen pantry, workshop, toolbox, or supply closet. The vehicle system 104 includes one or more processors 134, one or more sensor devices 112, one or more output devices 136, one or more storage pod control devices 138, a user profile module 140, a user recognition module 142, an intent recognition module 144, an interaction module 146, a security and authentication module 148, an inventory data store 150, and a service data store 152. The components of the vehicle system 104 can be implemented in hardware, software, firmware, or a combination thereof.

In one or more examples, the vehicle 102 implements context-aware personalization and multi-functional service delivery at the proximal space 108 by relying entirely on the vehicle system 104. For example, the vehicle system 104 implements context-aware personalization and multi-functional service delivery without communicating with external devices. In at least one other example, the vehicle system 104 is aided by the remote service(s) 120 and/or the remote data source(s) 122 executing on one or more remote computing systems, which share a connection to the vehicle 102 over the network(s) 124. For example, the remote service(s) 120 execute on one or more remote servers to enhance the functionality of the vehicle system 104. The vehicle system 104 may communicate through the network(s) 124 to offload data or tasks to be handled by the remote service(s) 120. Upon receiving the data or requests from the vehicle system 104, the remote service(s) 120 are configured to remotely process the data or remotely perform the tasks on behalf of the vehicle 102. Examples of the remote service(s) 120 include external databases, application program interfaces (APIs), external processors, cloud platforms, Internet of Things (IoT) devices, computer-readable storage devices, other vehicles, and the like.

In at least one example, the processors 134 are electronic circuits that process instructions for executing functions on the vehicle 102. Execution of the functions enables the processors 134 to implement vehicle operations for achieving smooth and safe driving by the vehicle 102 and for facilitating safe human interactions with the vehicle 102. The processors 134 are also referred to as processing devices, some examples of which include but are not limited to a central processing unit (CPU), a graphics processing unit (GPU), a field programmable gate array (FPGA), an accelerator, an accelerated processing unit (APU), a system on chip (SoC), a microcontroller, an electronic control unit (ECU), and a digital signal processor (DSP), to name a few. In one or more variations, the processors 134 include multiple co-processors, multiple cores (e.g., a multi-core processor). In one or more other variations, the processors 134 include just one core (e.g., a single processor core).

The processors 134 rely on a memory to store the instructions for execution by the processors 134 that cause the vehicle 102 to implement various functions. For example, the vehicle 102 includes a memory circuit that stores instructions and data for executing a program (e.g., software, firmware). In one or more implementations, the memory corresponds to semiconductor memory where data is stored within memory cells on one or more integrated circuits. The memory of the processors 134 is used to store information, such as for managing merchandise and services distributed and hosted from the vehicle 102. In at least one example, the memory of the processors 134 corresponds to or includes volatile memory, examples of which include random-access memory (RAM), dynamic random-access memory (DRAM), synchronous dynamic random-access memory (SDRAM), static random-access memory (SRAM), and memristors. The memory of the processors 134 is configurable with any number of memory (e.g., physical memory) without departing from the spirit or scope of the described techniques. Alternatively, or in addition, the memory of the processors 134 corresponds to or includes non-volatile memory, examples of which include flash memory, read-only memory (ROM), programmable read-only memory (PROM), erasable programmable read-only memory (EPROM), electronically erasable programmable read-only memory (EEPROM), and non-volatile random-access memory (NVRAM), such as phase-change memory (PCM) and magneto resistive random-access memory (MRAM). Further examples of memory configurations include low-power double data rate (LPDDR), also known as LPDDR SDRAM. The memory of the processors 134 is configurable in a variety of ways capable of supporting vehicle controls and implementation of the described techniques.

The sensor devices 112 are vehicle components configured to detect characteristics of the proximal space 108, including changes to the characteristics. In one or more examples, the sensor devices 112 represent a sensor system that includes one or more of a camera sensor, a lidar sensor, a radar sensor, an ultrasonic sensor, a location positioning sensor, a temperature sensor, a pressure sensor, a communication sensor, a microphone, or other type of sensor. The sensor devices 112 may be configured to capture different perspectives of the proximal space 108, which are used for various purposes. For example, sensor data obtained from the sensor devices 112 (e.g., as part of the input data 114) is usable to identify the user 106, authenticate the user 106, and/or infer the intent 126 of the user 106 as the user 106 approaches or moves away from the vehicle 102. In addition, the sensor data obtained from the sensor devices 112 may be used to help the vehicle 102 navigate to or from a location (e.g., to park in a garage, to exit the garage).

In at least one example, the sensor devices 112 include a camera and the sensor data output from the sensor devices 112 includes one or more images of the proximal space 108 and the environment 100. These images may be still images, video images, thermal images, color enhanced images (e.g., low-light images, night vision images), or other types of images. For example, the images taken by a camera of the sensor devices 112 are surround-view images that provide partial or complete panoramic views of the proximal space 108 (e.g., from the perspective of the storage pods 132. The sensor devices 112 may include a lidar device, a radar device, or an ultrasonic device. For example, rather than taking camera images of the proximal space 108 and the environment 100, the lidar, radar, and/or ultrasonic devices produce measurement data for identifying objects in the proximal space 108 and/or the environment 100 and characteristics associated with the objects (e.g., characteristics identifying the package 110 as a package). As a lidar device, the sensor devices 112 may output a lidar point cloud as measurement data. As a radar device the sensor devices 112 may output a radar data cube as measurement data.

The sensor devices 112 are configurable in a variety of ways, including for implementing specific driving related functions (e.g., autonomous driving, collision avoidance, lane centering, automated parking) and/or for implementing non-driving related functions (e.g., user authentication, storage pod management, inventory tracking, and/or the interaction(s) 128). The sensor data output from the sensor devices 112 can include an object size, an object distance, an object shape, an object classification, an object position, an object orientation, an object direction, an object speed, or other object measurement. Alternatively, or in addition to object tracking and classification functions, the images and/or measurement data captured by the sensor devices 112 may enable security functions of the vehicle 102 (e.g., facial or voice recognition functions for authenticating the user 106). The sensor devices 112 are operable to generate sensor data for consumption by the processors 134, and the processors 134 are operable to facilitate the interaction(s) 128 between the user 106 and the vehicle 102, based on the sensor data output from the sensor devices 112.

The sensor devices 112 may be operable as input devices that generate sensor data, which the processors 134 interpret as user inputs (e.g., as part of the input data 114). In this way, the sensor devices 112 implement a human machine interface (HMI) that configures the vehicle 102 to receive commands and requests from the user 106 to influence vehicle functions. For example, the sensor devices 112 capture inputs from the user 106 in response to detecting body language of the user 106, hand gestures performed by the user 106, speech produced by the user 106, and the like.

The output devices 136 are components of the vehicle 102 that are configured to output information to external devices, other vehicles, and users of the vehicle 102, such as the user 106. One non-limiting example of the output devices 136 include a speaker or sound system configured to produce audible signals in the environment 100, or particularly within the proximal space 108. Another non-limiting example of the output devices 136 include a display or lighting system configured to produce visual signals in the environment 100, or particularly within the proximal space 108. For example, a display device of the output devices 136 is configured to generate a graphical user interface (GUI) or control lights to convey information to the user 106. The output devices 136 may be configured to produce audible, visual, or haptic signals of a user interface to indicate a menu of the inventory of items loaded on the vehicle 102, and other inventories of items loaded on other vehicles parked in a vicinity of the proximal space 108.

In one or more examples, the output devices 136 communicate with external devices, such as the proximal network devices 116 (e.g., smartphones or wearables), the remote service(s) 120, the remote data source(s) 122, home automation devices, garage door openers, other vehicles, and/or the like, including to transmit or receive data and requests exchanged via the network(s) 124. For example, the output devices 136 wirelessly communicate with a garage door opener at a location to cause a garage door to open or close as the vehicle 102 is leaving or returning to the location.

In at least one implementation, one or more of the sensor devices 112 and the output devices 136 are integrated in an HMI subsystem of the vehicle 102, such as an infotainment system, a vehicle console, a vehicle kiosk, or other vehicle interface. For example, the sensor devices 112 and the output devices 136 are accessible to occupants of the vehicle 102, the user 106, or other users outside the vehicle 102 to receive user input and provide user outputs. The output devices 136 can include a vehicle display that presents a GUI, which is controlled via touch input, gesture input, or voice input made by the user 106, which is received by the sensor devices 112.

The storage pod control devices 138 enable the vehicle 102 to automatically control the storage pods 132 for implementing the interaction(s) 128. For example, the storage pod control devices 138 can control locks and actuators on the storage pods 132 and/or the vehicle 102 to cause access panels or doors in the storage pods 132 to open or close (e.g., to allow the user 106 to load or unload items, such as the package 110, to and from the vehicle 102). The storage pod control devices 138 may manage the detachment and subsequent reattachment of the storage pods 132 from the vehicle 102. For example, the vehicle 102 is operable to leave one or more of the storage pods 132 behind for the convenience of the user 106 when the vehicle 102 travels away from a specific location, such as the user's 106 home (e.g., to empty waste or replenish items). In one or more implementations, the storage pod control devices 138 include microcontrollers or specialized processing devices that are operable to maneuver the storage pods 132, individually, after being released (e.g., detached) from the vehicle 102. When the storage pods 132 are detached from the vehicle 102, the storage pod control devices 138 may maneuver the storage pods 132 away from the vehicle 102 (e.g., adjacent to a garage wall or corner). When the storage pods 132 are reattached to the vehicle 102, the storage pod control devices 138 can maneuver the storage pods 132 onto the vehicle 102, including in one or more implementations, to cause the storage pods 132 to be physically secured to the vehicle 102.

The user profile module 140 may be implemented using one or more of hardware, software, and firmware. For example, in some implementations, the user profile module 140 is an application executed by the processors 134 to manage collect, aggregate, and manage diverse data types, including the input data 114, the contextual data 118, the intent 126, the interaction(s) 128, user identifiers, user preferences, transaction history, and behavioral patterns. The user profile module 140 is configured to update user profiles in real time based on new data and/or user feedback, ensuring the user profiles accurately reflect the current preferences and needs of users, such as the user 106. In one or more implementations, the user profile module 140 utilizes machine learning algorithms to analyze historical data, identifying patterns and preferences to predict future needs or actions, thereby enhancing personalization. The user profile module 140 ensures that the interaction(s) 128 are tailored to the specific characteristics and situational context of users, such as the user 106.

The user recognition module 142 may be implemented using one or more of hardware, software, and firmware. The user recognition module 142 is configured to identify and authenticate users, such as the user 106, interacting with the vehicle 102. The user recognition module 142 ensures that the services, preferences, and access rights are correctly matched to the user's identity, providing a personalized and secure experience.

In some implementations, the user recognition module 142 is configured to identify users based on one or more biometric identifiers. For instance, the user recognition module 142 can utilize unique physical or behavioral characteristics for identification, such as fingerprints, facial recognition, iris scans, and voiceprints obtained via the sensor device(s) 112.

In some implementations, the user recognition module 142 is configured to identify users based on one or more secure digital keys or tokens obtained through authentication processes. In this manner, the user recognition module 142 can represent the identity of the user 106 without direct transmission of sensitive details.

In some implementations, the user recognition module 142 is configured to identify users through a wearable device identifier. For instance, the proximal network device 116 implemented as a smartwatch or fitness tracker can communicate with the vehicle system 104 to authenticate the user 106 without explicitly identifying the user 106.

In some implementations, the user recognition module 142 is configured to identify users via existing credentials, such as email or social media account credentials. In this manner, users can utilize services based on authentication using an existing online identity.

In some implementations, the user recognition module 142 identifies users based appearance so as distinguish one user from another, but does not attempt to personally identify users as specific individuals. For instance, the user recognition module 142 may identify one user as a man with a yellow hat and another user as a woman in a red dress.

The user recognition module 142 can utilize machine learning to process collected data (e.g., the input data 114) to match the collected data against known user profiles. This process may involve pattern recognition, biometric analysis, and anomaly detection to ensure accuracy and prevent unauthorized access. Upon successfully matching the collected data with a user profile, the user recognition module 142 can authenticate the associated user, granting access to personalized settings, preferences, and restricted functionalities based on the user profile and permissions.

The user recognition module 142 can continuously improve recognition accuracy through machine learning, adjusting algorithms based on success rates, user corrections, and the introduction of new identification technologies.

The intent recognition module 144 can predict the intent 126 of the user 106 during their interaction with the vehicle 102. The intent recognition module 144 interprets commands, actions, and context to determine what the user intends to achieve, enhancing the responsiveness and personalization of the interaction(s) 128 between the user 106 and the vehicle 102.

The intent recognition module 144 integrates the input data 114 from user interactions (e.g., voice commands, gestures, selections) with the contextual data 118 (e.g., location, time, user's historical behavior) to form a comprehensive view of the user's current state within the proximal space 108 of the vehicle 102. In one or more implementations, the intent recognition module 144 employs natural language processing (NLP) for understanding verbal inputs and machine learning algorithms for interpreting gestures and contextual cues. The intent recognition module 144 can categorize these inputs into predefined intent categories or dynamically infer new intents based on patterns.

In some implementations, the intent recognition module 144 uses predictive models to assign likelihood scores to various intents 126 based on the analysis, selecting a most probable intent 126 and associating that intent 126 with one or more interactions 128. The intent recognition module 144 can refine intent predictions over time through feedback mechanisms, learning from user corrections, preferences, and behavior patterns to enhance future accuracy and personalization.

The interaction module 146 can manage the interaction(s) 128 between the user 106 and the vehicle 102, facilitating communication, service delivery, and feedback collection. The interaction module 146 acts as the interface through which personalized content, services, and responses are presented to the user 106 based on their recognized identity and intent 126.

The interaction module 146 can coordinate the delivery of services, information, or actions that match the user's identified needs and preferences based on output received from the user recognition module 142 and the intent recognition module 144. The interaction module 146 can utilize various interfaces (e.g., graphical displays, voice responses, haptic feedback) to present information and available options to the user 106 in an accessible, understandable, and personalized manner. The interaction module 146 can adapts the presentation based on user profiles, preferences, and the capabilities of the vehicle 102.

The interaction module 146 can integrate mechanisms for collecting user feedback on the quality, relevance, and accuracy of the interactions and services provided. This feedback can be used to assess user satisfaction and to inform system improvements.

The interaction module 146 can analyze interaction patterns, feedback, and user engagement to continuously refine system responses, service offerings, and interaction styles. This iterative process aims to improve user experience, satisfaction, and system effectiveness over time.

The security and authentication module 148 safeguards the vehicle system 104 and data against unauthorized access and ensures that only authenticated users can access their profiles and initiate transactions. The security and authentication module 148 can encompass a range of security measures and protocols to protect data integrity and privacy. The security and authentication module 148 may be implemented using one or more of hardware, software, and firmware. For example, the security and authentication module 148 is an application executed by the processors 134. The security and authentication module 148 can implement encryption to secure data at rest and in transit, protecting sensitive information such as personal identifiers and transaction records. The security and authentication module 148 can manage access controls and permissions, ensuring users can only access data and features appropriate to their authentication level. The security and authentication module 148 can coordinate multi-factor authentication processes, combining something the user knows (password), something the user has (a device), something the user is (biometric data) to verify identity. The security and authentication module 148 can monitor the proximal space 108 for unusual or suspicious activity, employing anomaly detection algorithms to identify potential security threats and initiate protective actions (e.g., lockdown the storage pods 132 to prevent theft). The security and authentication module 148 also ensures compliance with relevant data protection laws, rules, and regulations, safeguarding user privacy and fostering trust.

The inventory data store 150 is maintained in a memory of the vehicle system 104, which is accessible to the interaction module 146 (e.g., when executed by the processors 134). The inventory data store 150 may be a database or a set of lists or other data structures that maintains information or data for tracking quantities, descriptions, prices, and other properties of items that are available from the storage pods 132. When items are removed from the storage pods 132, the inventory data store 150 is updated to reflect the change in the inventory on the vehicle 102. Likewise, when the storage pods 132 are refilled, the inventory data store 150 is modified to reflect the current state of the items contained therein. The interaction module 146 interfaces with the inventory data store 150 to obtain information for informing the user 106 about goods available from the vehicle 102. The information obtained from the inventory data store 150 is used by the interaction module 146 to allow the user 106 to interact with the vehicle 102 through the interaction(s) 128, such as to transact with the vehicle 102 and purchase or otherwise obtain the items contained in the storage pods 132.

Similar to the inventory data store 150, the service data store 152 may be a database or a set of lists or other data structures that maintains information or data for tracking the services offered by the vehicle 102. The interaction module 146 interfaces with the service data store 152 to obtain information for informing the user 106 about service available from the vehicle 102. The information obtained from the service data store 150 is used by the interaction module 146 to allow the user 106 to interact with the vehicle 102 through the interaction(s) 128 as part of providing one or more services to the user 106.

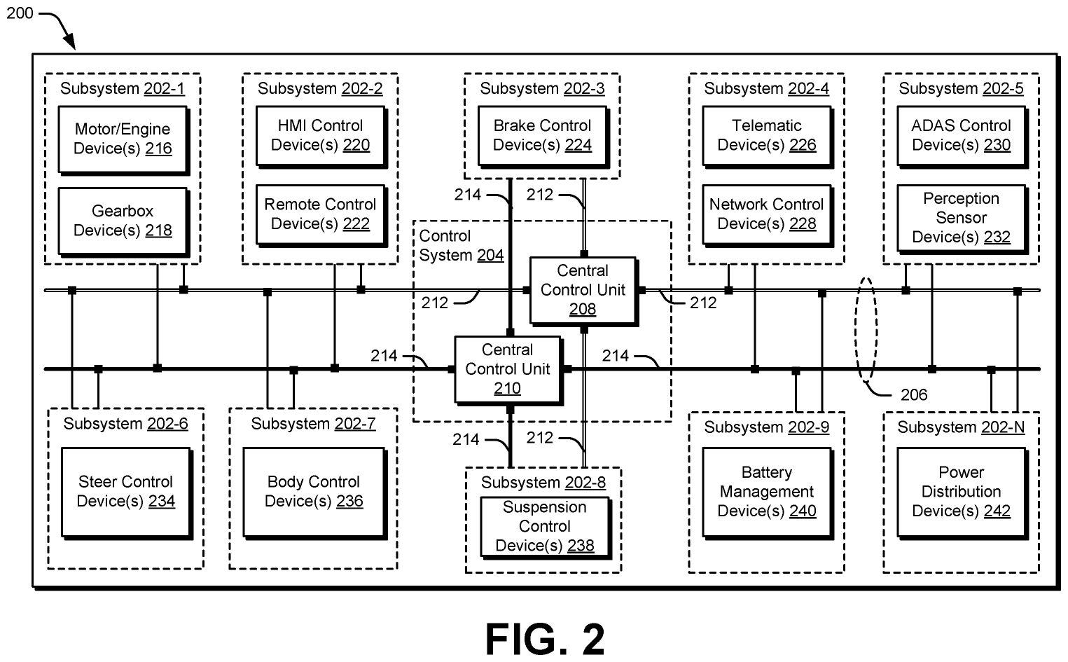

FIG. 2 is a block diagram of a non-limiting example of a vehicle system 200 of an autonomous vehicle that provides context-aware personalization and multi-functional service delivery. For ease of description, the vehicle system 200 is described in the context of the environment 100 shown in FIG. 1 including with reference to similar labeled elements. For example, the vehicle system 200 is a more-detailed version of the vehicle system 104 installed in the vehicle 102. The vehicle system 200 includes a plurality of subsystems 202 (labeled individually as subsystem 202-1 through subsystem 202-N, where N is any integer) that are managed by a control system 204 to implement various vehicle functions. In at least one example, the vehicle system 200 includes additional or fewer subsystems 202 than those depicted in FIG. 2.

The control system 204 is configured as a centralized controller that enables information to transfer between the subsystems 202 over a network 206. By exchanging information with the subsystems 202, the control system 204 causes the subsystems 202 to execute subsystem functions that enable driving or delivering messages to people in a vicinity of the vehicle 102 (e.g., in the environment 100). For instance, the control system 204 receives signals output on the network 206 from one of the subsystems 202, and based on information inferred from the signals, the control system 204 outputs additional signals on the network 206 to cause a particular behavior of another of the subsystems 202.

The control system 204 includes a central control unit 208 and a central control unit 210. The central control unit 208 and the central control unit 210 represent separate processors, processor cores, control units, microcontrollers, system on chips, or other processor technology. For example, the central control unit 208 and the central control unit 210 are examples of the processors 134. The central control unit 208 and the central control unit 210 may execute the user profile module 140, the user recognition module 142, the intent recognition module 144, the interaction module 146, the security and authentication module 148, and may maintain the inventory data store 150 and/or the service data store 152. In this way, each of the central control unit 208 and the central control unit 210 are configured to execute instructions either as software or firmware to implement functionality of the vehicle 102 and the control system 204. Although not shown, in some examples, the control system 204 includes a non-transitory computer-readable storage medium (e.g., data store, cache, static memory, dynamic memory, flash memory, disk storage) that maintains the instructions and data for implementing the instructions executed by each of the central control unit 208 and the central control unit 210. For example, the central control unit 208 and the central control unit 210 include respective data stores that contain the instructions, which upon retrieval from the data stores, are executed during operation of the vehicle 102. In one or more examples, data and instructions for implementing the user profile module 140, the user recognition module 142, the intent recognition module 144, the interaction module 146, the security and authentication module 148, the inventory data store 150, and/or the service data store 152 are executed by one or more of the central control unit 208 and the central control unit 210.

In another implementation, the control system 204 is distributed throughout the vehicle system 200 in two or more locations. In such a distributed implementation, the central control unit 208 is included in a first part of the control system 204 arranged at one part of the vehicle 102 (e.g., a front portion) and the central control unit 210 is included in a second part of the control system 204 positioned at another part of the vehicle 102 (e.g., a rear portion). In other distributed implementations, each part of the control system 204 includes one or more multiple instances of the central control unit 208 and/or the central control unit 210.

In one or more examples, the central control unit 208 and the central control unit 210 are functionally redundant. For example, the processors of each of the central control unit 208 and the central control unit 210 are operable to concurrently receive a same set of inputs from the subsystems 202 and concurrently send a same set of outputs to the subsystems 202. In a similar way, the processors of each of the central control unit 208 and the central control unit 210 are operable to concurrently receive the same set of inputs from the subsystems 202 and concurrently send the same set of outputs to the subsystems 202 regardless of whether that processor is being used to actively control operations of the vehicle 102.

The subsystems 202 of the vehicle system 200 rely on equivalent control operations of either the central control unit 208 or the central control unit 210 (e.g., one at a time) to actively cause vehicle operations or vehicle functions to be performed by the subsystems 202. For example, while the central control unit 208 is orchestrating operations of the subsystems 202, the central control unit 210 is maintained in a ready, standby state. If the central control unit 208 fails, then the control system 204 activates the central control unit 210 to take over and manage the subsystems 202 where the central control unit 208 left off. When the central control unit 210 takes over, the vehicle 102 may be forced to operate in a safe state, which can include maneuvering away from other vehicles, objects, and pedestrians to come to a controlled stop. This way, the functional redundancy implemented by the central control unit 208 and the central control unit 210 help the control system 204 to satisfy requirements for reliability and safety. In such implementations, the central control unit 208 and the central control unit 210 may be located at different locations within the vehicle.

The network 206 represents any suitable vehicle network technology, including wired and wireless signal propagation mediums. The network 206 enables real-time data exchange, safety enhancements, and efficient traffic management among the components of the vehicle system 200. The network 206 can include various switches, routers, transceivers, controllers, chokes, filters, terminations, and other networking equipment beyond transmission lines, cables, wires, busses, and other signal routing technologies. In an aspect, the network 206 adheres to an in-vehicle networking protocol. For example, the network 206 represents a combination of one or more of a controller area network (CAN), an automotive ethernet network (AEN), serializer/deserializer (SerDes) network, local interconnect network (LIN), or a FlexRay network (FRN).

In at least one example, to implement the redundancy of the control system 204, the network 206 is composed of dual physical network paths or network channels. In at least one example, the central control unit 208 and the central control unit 210 are operable to concurrently exchange a same set of inputs and outputs with the subsystems 202 over different respective channels (e.g., logical channels, physical channels) of the network 206 that link the subsystems 202 to that central control unit (e.g., the processors 134). A network channel 212 or network path communicatively couples each of the subsystems 202 to the central control unit 208. A separate network channel 214 or network path communicatively links each of the subsystems 202 to the central control unit 210. For example, the network channel 212 is utilized by the central control unit 208 to exchange data over the network 206, and the network channel 214 is utilized by the central control unit 210 to exchange data over the network 206. In at least one implementation, if a failure at the central control units 208 is at least partially caused by a fault in the network channel 212, the central control unit 210 is unaffected by the network fault and operable to communicate with the subsystems 202 using the network channel 214. The functional redundancy implemented by the network channel 212 and the network channel 214 further helps the control system 204 to satisfy the requirements for reliability and safety.

In at least one other example, to implement the redundancy of the control system 204, the network 206 is composed of dual logical network paths or channels. The network channel 212 and the network channel 214 may be separate logical paths through the network 206 that communicatively link each of the subsystems 202 to the central control unit 208 and the central control unit 210 using the same physical wires. In at least one example, the central control unit 208 and the central control unit 210 are operable to interleave a same set of inputs and outputs concurrently exchanged with the subsystems 202 over a same set of channels (e.g., logical or physical channels) of the network 206 that link the subsystems 202 to that central control unit (e.g., the processors 134). For example, communications two and from the central control unit 208 and the central control unit 210 are interleaved on a single set of wires that make up the network 206. If a failure at the central control unit 210 and/or the network channel 214 occurs, communications from the central control unit 208 can reach the subsystems 202 using the network channel 212. The functional redundancy implemented by interleaving the network channel 212 and the network channel 214 further helps the control system 204 to satisfy the requirements for reliability and safety.

The subsystems 202 include one or more edge devices (e.g., the sensor devices 112, the output devices 136, the storage pod control devices 138) operatively coupled to the network 206 to provide information to the control system 204 and receive commands from the control system 204 to implement various vehicle functions. For example, each of the subsystems 202 can include one or more actuators, microcontrollers, machines, or other equipment to perform specific vehicle tasks at the discretion of the edge devices that are contained within the subsystems 202. The sensor devices 112, the output devices 136, and the storage pod control devices 138 are not shown in FIG. 2, however, each is included among one or multiple of the subsystems 202.

A subsystem 202-1 is a propulsion or drive subsystem. Motor/engine devices 216 of the subsystem 202-1 represent edge devices managed by the control system 204 to command vehicle propulsion units (e.g., an engine, a motor) to execute driving functions of the vehicle 102 (e.g., forward motion, reverse motion, acceleration, deceleration). In one or more examples, the motor/engine devices 216 manages operations of an engine of the vehicle 102, including fuel injection, ignition timing, emissions control, and engine health monitoring. In at least one aspect (e.g., in context of electric vehicles), the motor/engine devices 216 control inverters and motors that convert electric energy into mechanical energy for applying torque to wheels.

In addition, the subsystem 202-1 includes gearbox devices 218. Also referred to as a powertrain control module (PCM) and/or a transmission control module (TCM), transmission and gearbox functions are overseen by the gearbox devices 218 to implement an automatic transmission, optimize gear changes (e.g., gear shifts), and control torque delivered to the wheels of the vehicle 102. A vehicle may include one or more instances of the subsystem 202-1 (e.g., one subsystem 202-1 for each axle).

A subsystem 202-2 is an HMI subsystem. The subsystem 202-2 includes one or more HMI control devices 220 that implement a vehicle user interface. For example, the HMI control devices 220 include one or more of the sensor devices 112 and one or more of the output devices 136. The vehicle user interface enables interaction between occupants (e.g., driver, passenger) of the vehicle 102 and the vehicle system 200, which enables human intervention in vehicle functions and driving. The vehicle user interface further enables interaction between people outside the vehicle (e.g., the user 106) and the vehicle system 200. For example, the HMI control devices 220 control the output devices 136 (e.g., vehicle displays, vehicle dash clusters, head-up display units, haptic feedback, audible feedback, and other visual aids) to help with driving or implementing the techniques described herein. In one or more implementations, the HMI control devices 220 configure one or more of the sensor devices 112 as HMI input devices to provide a human-interface to effect delivery of items or inventory made available from the vehicle 102, or vehicle operations, such as climate controls (e.g., heating, cooling), cabin features (e.g., infotainment, lighting), other vehicle body features (e.g., windshield wipers, transmission settings, suspension settings, drive mode selection, power seating, power mirrors, power door locks).

The subsystem 202-2 also includes one or more remote control devices 222 that allow human or machine inputs to control the vehicle 102 from outside the cabin. For example, in an autonomous or semi-autonomous vehicle context, the remote control devices 222 receive commands over a communication link with a base station (e.g., a mobile phone, a key fob, part of the network(s) 124) to allow a human or machine operator to control the vehicle 102 as if the driving commands are provided directly to the HMI control devices 220. In hot or cold weather, to pre-cool or pre-heat the cabin, the remote control devices 222 activate remote starting functions. The remote control devices 222 in at least one aspect allow door locks to be unlocked or locked and doors, tailgates, or trunks to be remotely opened or closed.

A subsystem 202-3 represents a braking subsystem of the vehicle system 200. For example, one or more brake control devices 224 are operable to manage anti-lock braking systems (ABS), electronic stability controls (ESC), and otherwise convert driver inputs at the HMI control devices 220 to effect performance of vehicle brakes (e.g., for stopping, for decelerating). In some examples, the brake control devices 224 represent a braking control module (BCM).

Another of the subsystems 202 depicted in FIG. 2 includes a subsystem 202-4, which is an onboard-vehicle communication subsystem. The subsystem 202-4 manages telematics and communications that occur within the vehicle 102, and with other devices located outside the vehicle 102. For example, the subsystem 202-4 interfaces with the various edge devices coupled to the network 206 to ensure healthy exchange of data that is free of errors or faults. In addition, the subsystem 202-4 interfaces with other vehicles, mobile devices, infrastructure, and remote computing systems to implement various vehicle functions. For example, the subsystems 202-4 interface (e.g., exchange data) with the remote service(s) 120 and/or the remote data source(s) 122 via a network connection through the network(s) 124. One or more network control devices 228 of the subsystem 202-4 monitor network health of the network 206 and facilitate communication protocols implemented therein. The network control devices 228 are configured to diagnose problems with the network 206 to reroute signals and prevent data loss.

One or more telematic devices 226 of the subsystem 202-4 handle offboard communications of the vehicle 102. This includes implementing vehicle-to-vehicle (V2V) and vehicle-to-everything (V2X) communications that enable the vehicle 102 to communicate with other intelligent vehicles and systems in an operating environment (e.g., on or near a roadway). The telematic devices 226 interface with over-the-air (OTA) update services to update software on the vehicle 102. In addition, the telematic devices 226 interface with a positioning system to assist with navigation functions. Other features implemented by the telematic devices 226 include remote diagnostics, and interfacing with emergency response services (e.g., to automatically alert emergency responders in the event of an accident, to automatically receive emergency alerts for dispatching the vehicle 102 to provide medical supplies, medicine, medical equipment to an emergency location).

A subsystem 202-5 is an advanced driving and safety (ADAS) subsystem of the vehicle system 200. The subsystem 202-5 has two main functions, including implementing an ADAS as well as a perception sensor system. For example, one or more ADAS control devices 230 implement ADAS functionality that includes autonomous or semi-autonomous control, adaptive cruise control, emergency braking, lane centering, and other ADAS functions. One or more perception sensor devices 232 support the ADAS control devices 230 by providing information about the driving environment to ensure safe driving and/or safe interactions with people and other vehicles or machines located in the environment 100. For example, a radar, a camera, a lidar, an ultrasonic sensor, a global position system (GPS) sensor, an inertial measurement unit (IMU), and other sensor technology are examples of the sensor devices 112 that are deployed by the perception sensor devices 232 to collect sensor data about the environment 100. Sensor fusion techniques, object detection, lane centering, path trajectory planning, and other perception sensor functions are executed by the perception sensor devices 232 to enable the ADAS functions performed by the ADAS control devices 230.

A subsystem 202-6 is a steering subsystem that controls elements of the vehicle, which steer the wheels. One or more steer control devices 234 integrate with an electric power steering system of the vehicle 102 to control direction of the vehicle wheels. The steer control devices 234 receive inputs from the HMI control devices 220 and/or the control system 204, which are translated into appropriate steering commands for controlling steering actuators that change the direction of the wheels for steering and performing evasive maneuvers.

A subsystem 202-7 represents a body control subsystem of the vehicle 102. Included in the subsystem 202-7 are one or more body control devices 236, which oversee functions related to vehicle body controls. For example, window actuators, door locks and latches, interior and exterior lighting, tailgate and trunk latches, and the like are controlled by the body control devices 236 at the command of the control system 204 and/or one or more of the other subsystems 202 (e.g., the HMI control devices 220). In one or more examples, the storage pod control devices 138 are included within the subsystem 202-7. For example, like body controls on the vehicle 102, storage pod controls are operable to open, close, lock, or unlock the storage pods 132 to provide or restrict access to items in the inventory of the vehicle 102.

A subsystem 202-8 is an active suspension control subsystem. One or more suspension control devices 238 implement functions of a suspension control module (SCM) to regulate suspension components to adjust a ride level of the vehicle 102. For example, the suspension control devices 238 configure a vehicle suspension to be stiffer on paved surfaces for improved driving performance and maneuverability. In an offroad setting, the suspension control devices 238 enable a softer suspension setting to provide a smoother ride.

A subsystem 202-9 represents a battery management subsystem of the vehicle 102. One or more battery management devices 240 monitor performance of a battery pack (also referred to as a traction battery) to ensure appropriate charging and discharging rates to promote longevity and overall battery health. The battery management devices 240 control charging operations of on board vehicle batteries as well as controlling battery usage (e.g., to control a rate of discharge). The battery management devices 240 monitor health of vehicle batteries to alert the control system 204 when a malfunction is imminent or occurring.

Finally, a subsystem 202-N is depicted in FIG. 2, which represents a power distribution system. One or more power distribution devices 242 of the subsystem 202-N manage the distribution of electrical power from energy sources on the vehicle 102 to the vehicle system 200. For example, the power distribution devices 242 control power switches, inverters, converters, and other electrical distribution components to ensure the subsystems 202 receive an appropriate level of current and voltage for implementing vehicle functions. The power distribution devices 242 can include fault protection circuits and breakers to interrupt power to a faulty subsystem and maintain safe electrical conditions while the vehicle 102 remains active. The power distribution devices 242 interface with the motor/engine devices 216 and the battery management devices 240 to manage safe electrical conditions throughout the vehicle system 200.

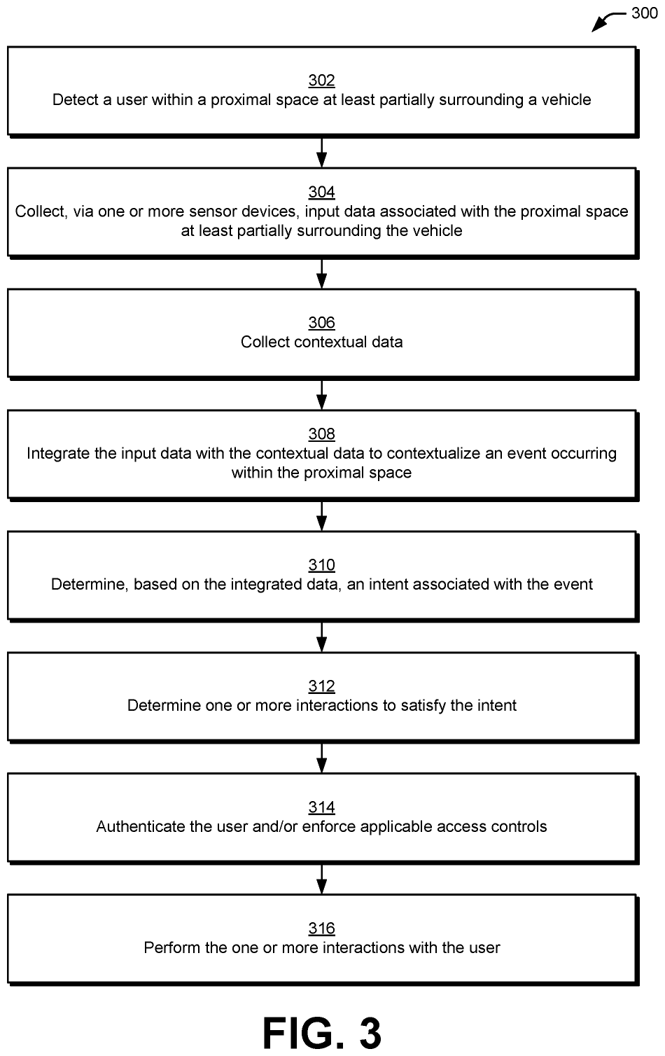

FIG. 3 depicts a procedure 300 to provide a seamless, personalized user experience with an autonomous vehicle system, such as the vehicle system 104. The procedure 300 begins at block 302, where the vehicle system 104 detects the user 106 within the proximal space 108 at least partially surrounding the vehicle 102. In one or more implementations, the vehicle system 104 detects the user 106 via the sensor device(s) 112, such as camera and/or proximity sensor.

At block 304, the vehicle system 104 collects, via the sensor device(s) 112 the input data 114 associated with the proximal space 108 at least partially surrounding the vehicle 102. For example, as the user 106 approaches the vehicle 102, the cameras capture visual cues, the microphones pick up any spoken words or sounds, and the lidar and radar sensors track the user's 106 movement towards the vehicle 102. The vehicle system 104 utilizes the sensor device(s) 112 to gather real-time data about the proximal space 108 surrounding the vehicle 102. The input data 114 is or includes the raw, direct information collected from various sources that indicates the user's 106 immediate actions, behaviors, or verbal commands. This includes data gathered through voice recognition (e.g., capturing spoken commands or queries), analysis of body movements and positioning (e.g., using the sensor device(s) 112 to detect gestures or proximity to the vehicle 102), facial expressions (e.g., utilizing facial recognition technology), and signals from the proximal network devices 116 (e.g., smartphones or wearables). The input data 114 provides the vehicle system 104 with primary indicators of the user's 106 potential needs or desires.

At block 306, the vehicle system 104 collects the contextual data 118. For example, the vehicle system 104 identifies that the time of day is early morning, and the user 106 is at their usual departure spot on a workday, adding layers of context to the observed approach of the user 106 towards the vehicle 102.

The contextual data 118 can be or can include a geographical position of the user 106, which can influence the relevance of information or services provided by the vehicle system 104. The contextual data 118 can be or can include time-related factors, including time of day, day of the week, and season, which can affect the needs and preferences of the user 106. The contextual data 118 can be or can include environmental conditions surrounding the user 106, such as weather, temperature, and ambient noise, which may impact the responses and suggestions provided by the vehicle system 104. The contextual data 118 can be or can include the presence of other people, the user's activities (e.g., working, leisure), and social settings. The contextual data 118 includes additional information that, when combined with the input data 114, provides a richer understanding of the user's 106 situation or environment. The contextual data 118 helps the vehicle system 104 to interpret the input data 114 within the framework of the user's 106 current circumstances, enhancing the accuracy of an intent 126 prediction.

At block 308, the vehicle system 104 integrates the input data 114 with the contextual data 118 to contextualize an event 130 occurring within the proximal space 108. For example, the vehicle system 104 the detection of the user's 106 approach towards the vehicle 102 with the knowledge that it is a weekday morning to determine that the user 106 intends to commence their daily commute.

The event 130 is or includes any occurrence or action detected by the vehicle system 104 (e.g., via the sensor(s) 112) that triggers a response or requires analysis. The event 130 can range from the user 106 approaching the vehicle 102 (as in the above example), initiating a verbal command, exhibiting a particular facial expression and/or body language, or any action that the vehicle system 104 can detect and to which the vehicle 102 might need to respond. In one or more implementations, the event 130 acts as the catalyst for the predictive and responsive capabilities of the vehicle system 104, initiating the process of intent recognition and service provision.

At block 310, the vehicle system 104 determines, based on the integrated data, an intent 126 of the user 106. For example, by analyzing the user's 106 approach towards the vehicle 102, coupled with the time and historical commuting patterns, the vehicle system 104 predicts the intent 126 of the user 106 is to drive/ride to work. If the user 106 verbally requests, “Take me to the office,” the vehicle system 104 further validates the intent 126 through natural language processing.

The intent 126 represents the underlying purpose or goal behind a user's 106 actions or commands as interpreted by the vehicle system 104. The intent 126 is what the user 106 aims to achieve through their interaction(s) 128 with the vehicle 102, such as obtaining information, requesting a service, expressing a desire for a particular good, or signaling a need that the vehicle 102 can fulfill. Understanding the intent 126 allows the vehicle system 104 to accurately predict and provide the most relevant and personalized responses or services to the user 106 as part of the interactions 128.

The intent 126 can be or can include informational intent, transactional intent, navigational intent, interactional intent, any combination thereof, and/or the like. Information intent, for instance, is when the user 106 seeks information, such as news updates, weather forecasts, or educational content. Transactional intent, for instance, is when the user 106 wants to perform a transaction, such as making a purchase, booking a service, or transferring funds. Navigational intent, for instance, is when the user 106 needs to find an item or service offered by the vehicle 102 (e.g., where the package 110 should be dropped off). Interactional intent, for instance, is when the user 106 wishes to interact the vehicle system 104 in some manner.

At block 312, the vehicle system 104 determine one or more interactions 128 to satisfy the intent 126. This could involve activating various subsystems of the vehicle 102, engaging external services (e.g., the remote service(s) 120), or prompting the user 106 for further information. For example, to satisfy the intent 126 of commuting to work, the vehicle system 104 might start the engine or power on the electric motor(s), adjust the interior settings to the user's preferences, plot the fastest route to the office considering current traffic conditions, and if necessary, suggest an earlier departure time to ensure timely arrival for the user's meeting.

The interaction(s) 128 encompasses the dynamic exchange between the user 106 and the vehicle 102, facilitated by the vehicle system 104 configured to interpret the input data 114 and the contextual data 118 to predict the intent 126. The interaction(s) 128 can manifest as direct commands from the user 106, responses provided by the vehicle 102, personalized service offerings based on predicted needs, or any engagement involving the vehicle 102 and the user 106. The interaction(s) 128 is shaped by the predictions made by the vehicle system 104 and the responses provided by the user 106, forming a continuous loop of communication and service provision.

The interaction(s) 128 can be or can include direct commands that the user 106 explicitly tells the vehicle system 104 what action to perform. The interaction(s) 128 can be or can include conversational interactions that represent more natural, dialogue-based exchanges where the user 106 and the vehicle system 104 communicate based and forth, allowing for clarification and adaptation, in addition to refining future interactions between the user 106 and the vehicle system 104. The interaction(s) 128 can be or can include predictive actions, where the vehicle system 104 anticipates the user's 106 needs based on context, data, and past behavior, suggesting actions or information without a direct command. The interaction(s) 128 can include automated services, where the vehicle system 104 autonomously performs tasks or services based on predetermined conditions or schedules, without needing real-time input from the user 106.

At block 314, the vehicle system 104 authenticates the user 106 and/or enforces any applicable access controls. For example, the vehicle system 104 can implement robust authentication mechanisms, utilizing a combination of biometric verification (e.g., facial recognition, fingerprint scanning), digital tokens, and/or other authentication credentials to verify the user's 106 identity before allowing the one or more interactions 128. The vehicle system 104 can additionally or alternatively enforce access controls for restricted goods or services (e.g., age-restricted items, content, and/or services) by verifying the user's 106 eligibility based on a user profile. This ensures that all the interaction(s) 128 are not only personalized but also comply with legal and security standards. At block 316, the vehicle system 104 performs the interaction(s) 128 with the user 106. Extending the example provided above, the vehicle system 104 facilitates transporting the user 106 to work.

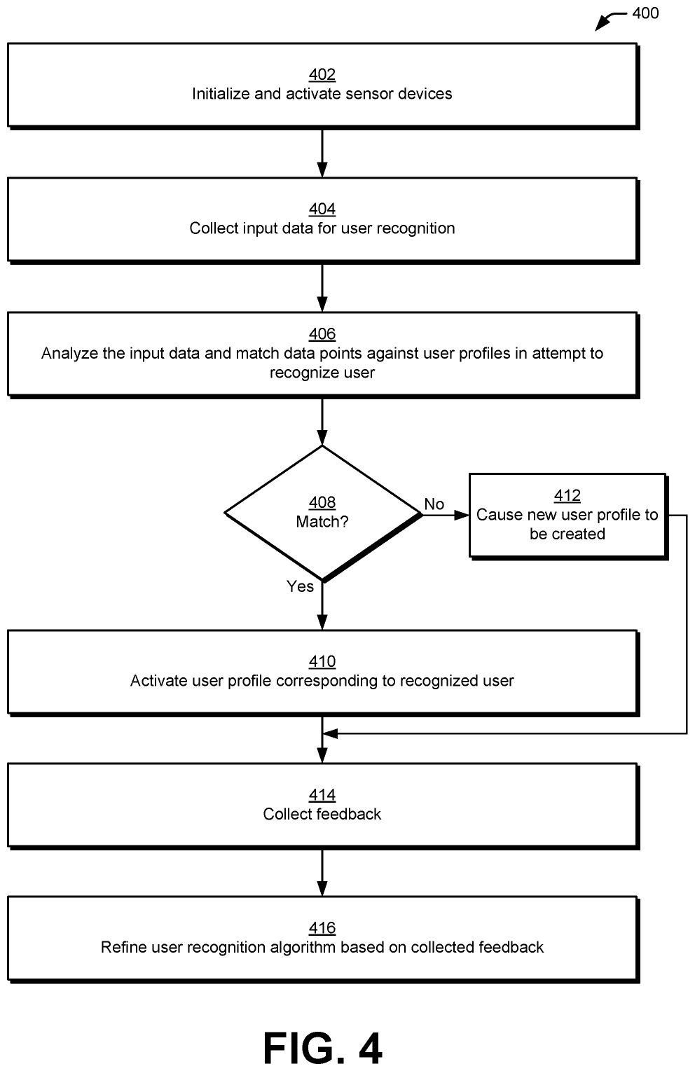

FIG. 4 depicts a procedure 400 implementing a user recognition algorithm via the user recognition module 142 to recognize a user, such as the user 106, within the proximal space 108 at least partially surrounding the vehicle 102. The procedure 400 will be described from the perspective of the user recognition module 142 being executed by the processor(s) 134. Alternatively, the user recognition module 142 can be implemented as a standalone system or subsystem of the vehicle system 104 having, for example, a dedicated processing unit.

The procedure 400 begins at block 402, where the user recognition module 142 initializes and activates the sensor device(s) 112. For example, as the user 106 approaches the vehicle 102, a motion sensor (e.g., implemented using infrared) can detect proximity of the user 106 within a certain range (e.g., within the proximal space 108), signifying a potential user interaction. Responsive to the motion sensor detecting proximity of the user 106, additional sensor device(s) 112 can be activated, such as a facial recognition cameras, short-range communication signal detectors (e.g., BLUETOOTH), and/or others. Alternatively, the motion sensor, facial recognition camera, and/or other sensor device(s) 112 can be activated simultaneously.

At block 404, the user recognition module 142 collects the input data 114 or a portion thereof for user recognition. The user recognition module 142 can collect a variety of data types simultaneously to ensure robust user identification. Collecting the input data 114 in this context can include capturing facial images for facial recognition, scanning for BLUETOOTH devices (like smartphones or wearables such as the proximal network devices 116) that are pre-registered to the user 106, voice recognition if the user 106 initiates verbal interaction with the vehicle 102, and so on. For example, as the user 106 speaks a command or greeting towards the vehicle 102, voice recognition software (separate or integrated as part of the user recognition module 142) processes the audio, cameras capture the user's 106 face for facial recognition, and the user recognition module 142 scans for the BLUETOOTH ID of the user's 106 smartphone.

At block 406, the user recognition module 142 analyzes the input data 114 with each modality (e.g., facial recognition, device ID, voice pattern) processed through its respective algorithm and attempts to match data points against the user profiles maintained by the user profile module 140. For example, the facial recognition algorithm attempts to match the captured image with a stored user profile, match the voice pattern to the user's 106 known voice signature, and match the detected BLUETOOTH device (e.g., the proximal network devices 116) is identified as belonging to the user 106.

At block 408, the user recognition module 142 determines if a match exists. If so, at block 410, the user recognition module 142 activates the user profile corresponding to the recognized user 106. The user recognition module 142 then activates any personalized settings and/or preferences for the vehicle 102, such as seat positioning, climate control settings, and preferred multimedia content. For example, user recognition module 142 can instruct the vehicle 102 to automatically adjust the interior temperature to their preferred setting, position the seat and mirrors according to their last saved preferences, and queues up the user's 106 favorite morning playlist. If not, at block 412, the user recognition module 142 causes a new user profile to be created for the user 106. For example, the user recognition module 142 provides the input data 114 collected at block 404 to the user profile module 140 to be used as part of creating a new user profile for the user 106.

At block 414, the user recognition module 142 collects feedback from the user recognition process, such as data corresponding to successful and unsuccessful user recognition attempts. At block 416, the user recognition module 142 refines the user recognition algorithm based on the collected feedback to improve accuracy. The user recognition module 142 can learn from every successful and unsuccessful recognition attempt, updating the user recognition algorithm and the user's profile with new data points or corrections made by the user 106. If the user recognition module 142 fails to recognize the user 106 due to a new hairstyle or accessory, for example, and the user 106 manually authenticates, the user recognition module 142 updates the facial recognition data for the user 106 with this new information (e.g., image of the user 106 with the new hairstyle) to improve future recognition accuracy for the user 106.

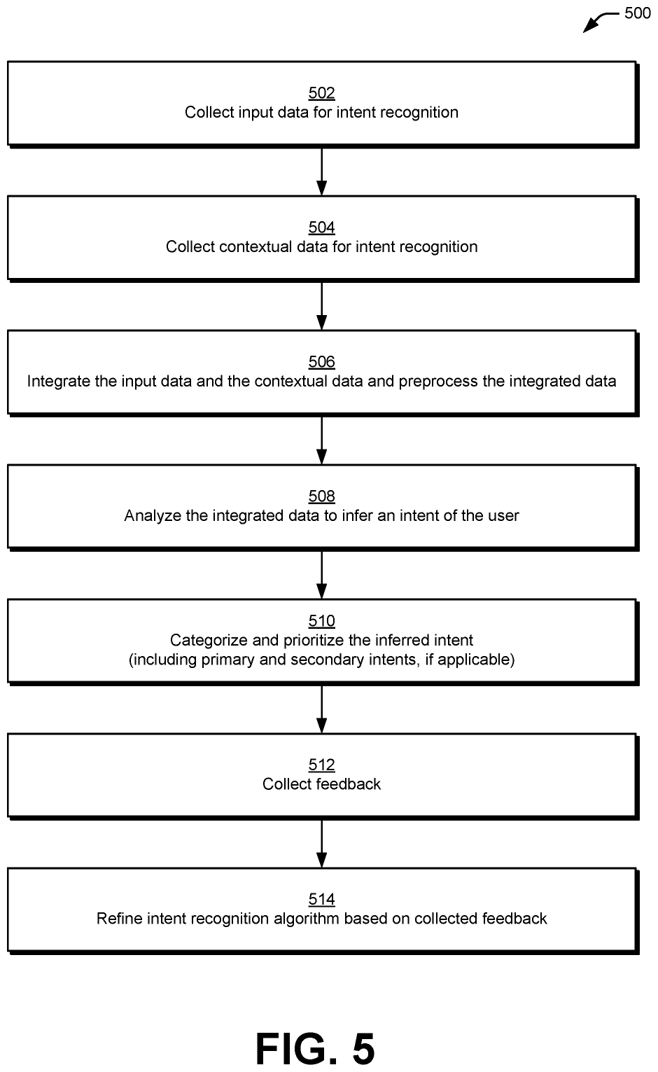

FIG. 5 depicts a procedure 500 implementing an intent recognition algorithm via the intent recognition module 144 to recognize an intent of a user, such as the intent 126 of the user 106. The procedure 500 will be described from the perspective of the intent recognition module 144 being executed by the processor(s) 134. Alternatively, the intent recognition module 144 can be implemented as a standalone system or subsystem of the vehicle system 104 having, for example, a dedicated processing unit.

At block 502, the intent recognition module 144 collects the input data 114 for intent recognition, which may include verbal commands captured through voice recognition technology and physical gestures observed by video cameras. For example, the user 106 may state, “I need to get to the airport,” while gesturing towards luggage they are carrying that needs to be loaded in the vehicle 102 (e.g., into one of the storage pods 132).

At block 504, the intent recognition module 144 collects the contextual data 118 for intent recognition. The intent recognition module 144 can collect the contextual data 118 in parallel to collecting the input data 114. The contextual data 118 can influence the interpretation of the intent 126 of the user 106. The contextual data 118 can include the current time, date, vehicle location, user's calendar events, recent destinations, and traffic and weather conditions. For example, the intent recognition module 144 can record the current time and cross-reference the current time to the user's digital calendar (e.g., with adequate permissions), identifying a scheduled flight. The intent recognition module 144 can also assess current traffic conditions to the airport, check the weather, and check the flight status.

At block 506, the intent recognition module 144 integrates the input data 114 and the contextual data 118 and preprocesses the integrated data. This preprocessing normalizes the data formats of the input data 114 and the contextual data 118 and resolves any ambiguities. For example, voice commands can be converted from speech to text, gesture data can be translated into actionable commands, and the integrated data can be structured in a format suitable for further analysis.

At block 508, the intent recognition module 144 analyzes the integrated data to infer the intent 126 of the user 106. The intent recognition module 144 can utilize artificial intelligence and machine learning models to perform this analysis, such as applying NLP to understand verbal commands, pattern recognition to interpret gestures, and predictive analytics to consider contextual cues. For example, an NLP algorithm can interpret the user's request related to the airport, while a predictive model can use the calendar event, time, and current location to infer the intent 126 to drive to the airport promptly.

At block 510, the intent recognition module 144 categorizes the intent 126 into one or more predefined actions (e.g., navigation, communication, entertainment) that the vehicle 102 can execute. If multiple intents 126 are detected, the intent recognition module 144 can also prioritize the intents 126 based on urgency, context, user preferences, and/or other criteria. For example, a primary intent can be identified as initiating navigation to the airport, but secondary intents, such as notifying a contact about the departure or playing calming music for the ride, can also be recognized and queued.

At block 512, the intent recognition module 144 collects feedback from the intent recognition process, such as direct user feedback, user behavior, and outcomes. At block 514, the intent recognition module 144 refines the intent recognition algorithm based on the collected feedback. For example, over time, the intent recognition module 144 can learn that the user 106 prefers scenic or less congested routes when not pressed for time, adjusting future navigation suggestions accordingly.

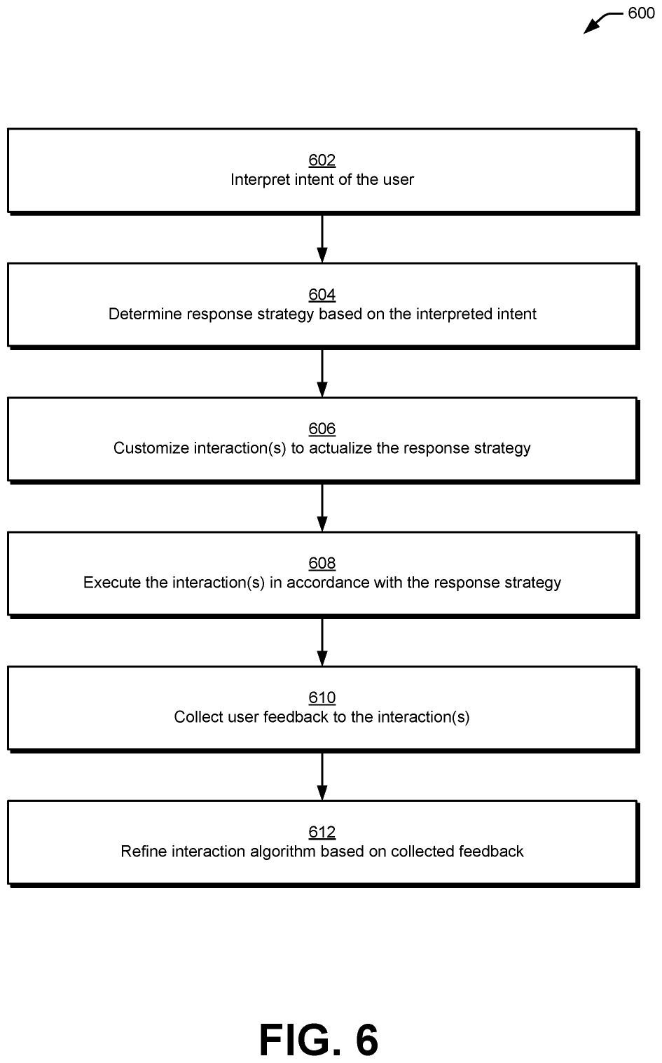

FIG. 6 depicts a procedure 600 implementing an interaction algorithm via the interaction module 146 to translate insights gained from the intent recognition module 144 into one or more interactions 128. The procedure 600 will be described from the perspective of the interaction module 146 being executed by the processor(s) 134. Alternatively, the interaction module 146 can be implemented as a standalone system or subsystem of the vehicle system 104 having, for example, a dedicated processing unit.

At block 602, the interaction module 146 receives and interprets the intent 126 of the user 106 as determined by the intent recognition module 144, along with any relevant contextual data 118. The interaction module 146 can also assess the nature, urgency, and any associated preferences or constraints of the intent 126. For example, recognizing that the user 106 is experiencing sudden discomfort when approaching the vehicle 102, the intent 126 can be interpreted as the user 106 seeking medical treatment. In this example, the contextual data 118 can include the user 106 stating, “I need to see a doctor right away,” which confirms to the interaction module 146 that the interpretation of the intent 126 to seek medical treatment is accurate.

At block 604, the interaction module 146, based on the intent 126 and context, the interaction module 146 can determine a response strategy. Continuing the above example, the interaction module 146 can determine that an appropriate response strategy to the intent 126 of the user 106 being to seek medical treatment is to determine a route from the current location of the vehicle 102 to the nearest hospital. Additionally, the interaction module 146 can engage the sensor device(s) 112 to assess the user 106 (e.g., prompt the user 106 to describe their condition) and can report (e.g., via the network(s) 124) to the hospital that the vehicle 102 is enroute with the user 106 with any preliminary details of the assessment.

At block 606, the interaction module 146 customizes one or more interactions 128 to actualize the determined response strategy. The interaction module 146 can customize the interaction(s) 128 according to the user's profile, historical preferences, and/or any specific instructions provided by the user 106, such as expressed as part of the intent 126.

At block 608, the interaction module 146 executes the interaction(s) 128 in accordance with the response strategy. For example, the interaction module 146 engages various subsystems 202 of the vehicle 102 or remote services 120 as needed to fulfill the intent 126. The interaction module 146 also manages the timing, sequence, and presentation of information to ensure clarity and ease of use.

At block 610, the interaction module 146 collects user feedback to the interaction(s) 128, including explicit (e.g., verbal or gesture confirmations or rejections) and/or implicit (e.g., non-response or deviation from the suggested action), to gauge the success of the interaction(s) 128. At block 612, leveraging the collected feedback, the interaction module 146 refines the interaction algorithm. For example, the interaction module 146 can update the response strategy for future interactions, learning from successes and missteps to refine its approach and better align with the user's preferences and behaviors.

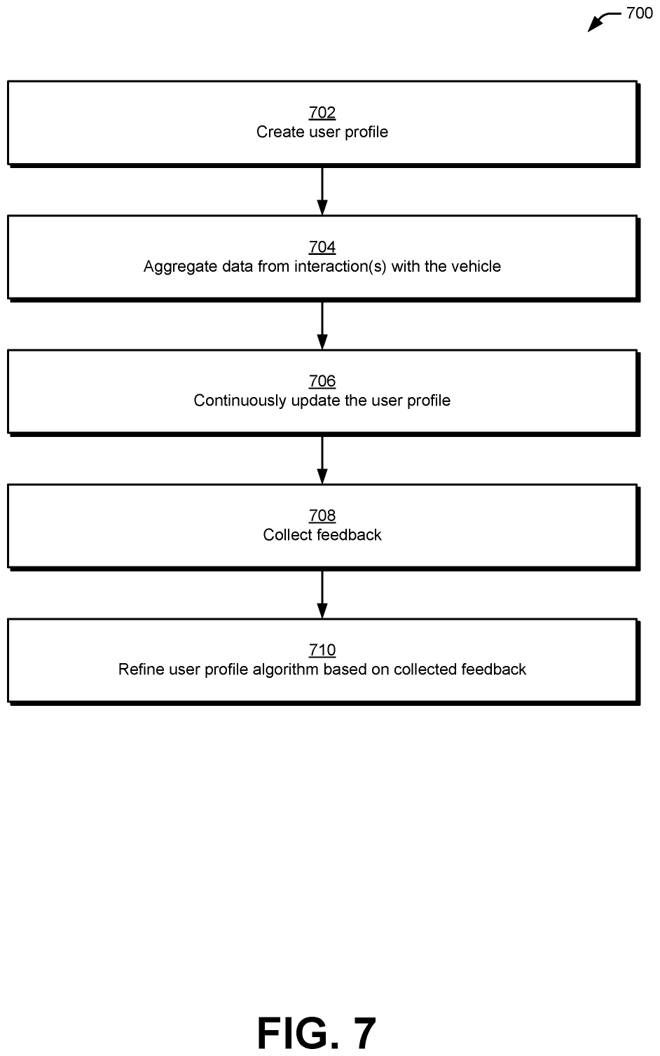

FIG. 7 depicts a procedure 700 implementing a user profile algorithm via the user profile module 140 to create and update user profiles. The procedure 700 will be described from the perspective of the user profile module 140 being executed by the processor(s) 134. Alternatively, the user profile module 140 can be implemented as a standalone system or subsystem of the vehicle system 104 having, for example, a dedicated processing unit.

At block 702, the user profile module 140 creates a user profile for a user, such as the user 106. For example, upon the first interaction with the vehicle 102, the user 106 is prompted to create a profile where they can input basic information such as name, contact details, and preferences (climate control settings, seat adjustments, entertainment choices, etc.).

At block 704, the user profile module 140 aggregates additional data, such as the input data 114, the contextual data 118, and other data from the interaction(s) 128 with the vehicle 102. At block 706, the user profile module 140 updates the user profile of the user 106 based on the additional data to reflect new preferences, changes in habits, or modifications to settings. This dynamic updating process ensures the user profile remains current and relevant.

At block 708, the user profile module 140 collects feedback such as the user 106 confirming, adjusting, or rejecting predictions and/or personalization efforts made by the vehicle 102, such as part of interpreting the intent 126 and performing the interaction(s) 128. At block 710, the user profile module 140 refines the user profile algorithm based on the collected feedback.

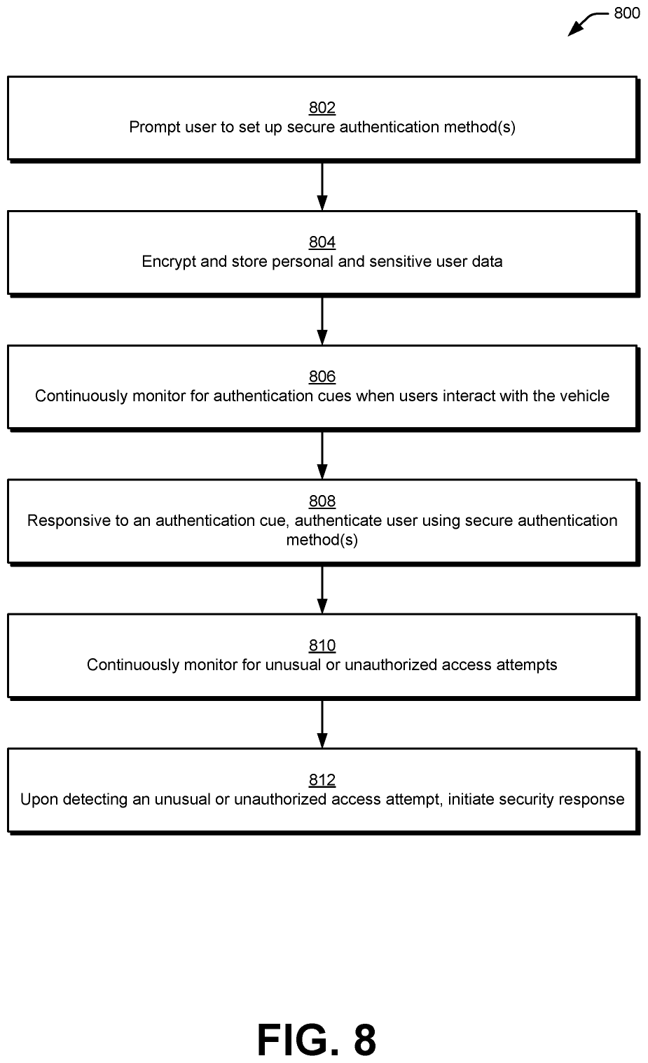

FIG. 8 depicts a procedure 800 implementing a security and authentication algorithm via the security and authentication module 148 to safeguard user data, ensure secure interactions, and manage access controls. The procedure 800 will be described from the perspective of the security and authentication module 148 being executed by the processor(s) 134. Alternatively, the security and authentication module 148 can be implemented as a standalone system or subsystem of the vehicle system 104 having, for example, a dedicated processing unit.

At block 802, the security and authentication module 148 can prompt the user 106 to set up one or more secure authentication methods. The secure authentication methods can include biometric data (e.g., facial recognition, fingerprint, voice pattern), a unique personal identification number, a digital token, or security questions. The security and authentication module 148 can prompt the user 106 to set up the secure authentication method(s) in response to the creation of a new user profile for the user 106.

At block 804, the security and authentication module 148 encrypts and stores personal and sensitive user data. For example, all personal and sensitive user data collected by the vehicle 102 are encrypted using advanced encryption standards. securely.

At block 806, the security and authentication module 148 continuously monitors for authentication cues when users interact (e.g., via the interaction(s) 128 and/or at other times as needed) with the vehicle 102, employing real-time data encryption for any data exchange. At block 808, responsive to an authentication cue, the security and authentication module 148 can assess the context and level of access required for each interaction, adjusting authentication requirements accordingly. For routine adjustments like climate control, the security and authentication module 148 may not require re-authentication. However, for sensitive actions like payment processing or accessing stored addresses, the security and authentication module 148 can prompt the user 106 for multi-factor authentication credentials.

At block 810, the security and authentication module 148 continuously monitors for unusual or unauthorized access attempts. The security and authentication module 148 can use one or more anomaly detection algorithm to detect suspicious activity. At block 812, upon detecting an unusual or unauthorized access attempt, the security and authentication module 148 initiates a security response. The security and authentication module 148 can lockdown the vehicle 102, emit alerts (e.g., audible and/or visual), and may prompt the user 106 for additional verification steps before proceeding with a certain interaction 128. For example, if an unrecognized face repeatedly attempts to access the vehicle 102, or if there is an attempt to access the vehicle system 104 from an unauthorized device, the vehicle 102 can lockdown and require manual verification, such as by the user 106, before allowing access to the vehicle 102.

Many variations are possible based on the disclosure herein. Although features and elements are described above in particular combinations, each feature or element is usable alone without the other features and elements or in various combinations with or without other features and elements.

The various functional units illustrated in the figures and/or described herein (including, where appropriate, the vehicle system 104, the sensor devices 112, the proximal network devices 116, the service(s) 120, the source(s) 122, the processors 134, the output devices 136, the storage pod control devices 138 the user profile module 140, the user recognition module 142, the intent recognition module 144, the interaction module 146, the security and authentication module 148) are implemented in any of a variety of different manners such as hardware circuitry, software or firmware executing on a programmable processor, or any combination of two or more of hardware, software, and firmware. The methods provided are implemented in any of a variety of devices, such as a general-purpose computer, a processor, or a processor core. Suitable processors include, by way of example, a general purpose processor, a special purpose processor, a conventional processor, a DSP, a GPU, a parallel accelerated processor, a plurality of microprocessors, one or more microprocessors in association with a DSP core, a controller, a microcontroller, Application Specific Integrated Circuits (ASICs), FPGAs, any other type of integrated circuit (IC), and/or a state machine.

In one or more implementations, the methods and procedures provided herein are implemented in a computer program, software, or firmware incorporated in a non-transitory computer-readable storage medium for execution by a general-purpose computer or a processor. Examples of non-transitory computer-readable storage mediums include a ROM, a RAM, a register, cache memory, semiconductor memory devices, magnetic media such as internal hard disks and removable disks, magneto-optical media, and optical media such as CD-ROM disks, and digital versatile disks (DVDs).

What is claimed is:

1. A method comprising:
collecting, by one or more sensors of a vehicle system, input data associated with a proximal space at least partially surrounding a vehicle;
collecting, by the vehicle system, contextual data;
integrating, by the vehicle system, the input data with the contextual data to contextualize an event occurring within the proximal space;
determining, by the vehicle system, based on the integrated data, an intent associated with the event; and
determining, by the vehicle system, an interaction to satisfy the intent.

2. The method of claim 1, wherein the input data indicates an immediate action, a behavior, or a verbal command provided by a user within the proximal space.

3. The method of claim 2, wherein the contextual data includes a geographical position of the user, a time-related factor, an environmental condition, or a presence of a person or an object.

4. The method of claim 3, wherein the intent is associated with the user procuring a good or a service from the vehicle.

5. The method of claim 1, further comprising authenticating, by the vehicle system, a user for the interaction.

6. The method of claim 1, further comprising performing, by the vehicle system, the interaction with a user.

7. The method of claim 6, wherein performing the interaction with the user includes actuating one or more subsystems of the vehicle.

8. A system comprising:
a processor;
a user recognition module executable by the processor to recognize a user within a proximal space at least partially surrounding a vehicle;
an intent recognition module executable by the processor to infer an intent of the user; and
an interaction module executable by the processor to interpret the intent of the user, determine an interaction to satisfy the intent, and execute the interaction.

9. The system of claim 8, further comprising a user profile module executable by the processor to:
create a user profile for the user;
aggregate data from at least the interaction; and
update the user profile based on the aggregated data.

10. The system of claim 8, further comprising a security and authentication module executable by the processor to:
encrypt and store user data associated with the user;
continuously monitor for an authentication cue when the user interacts with the vehicle;
responsive to the authentication cue, authenticate the user via one or more secure authentication methods;
continuously monitor for an unusual or unauthorized access attempt; and
responsive to detecting the unusual or unauthorized access attempt, initiate a security response.

11. The system of claim 8, wherein the user recognition module recognizes the user within the proximal space at least partially surrounding the vehicle via one or more sensor devices.

12. The system of claim 8, wherein the intent recognition module infers the intent of the user based on data collected from one or more sensor devices.

13. The system of claim 12, wherein the intent recognition module infers the intent of the user based on contextual data.

14. The system of claim 8, wherein the intent recognition module infers a plurality of intents including the intent.

15. The system of claim 14, wherein the intent recognition module categorizes and prioritizes the plurality of intents.

16. The system of claim 8, wherein the interaction module determines the interaction to satisfy the intent based on a response strategy.

17. A computer-readable storage medium having instructions stored thereon that, when executed by a processor, cause the processor to perform operations comprising:
collecting, by one or more sensors, input data associated with a proximal space at least partially surrounding a vehicle;
collecting contextual data;
integrating the input data with the contextual data to contextualize an event occurring within the proximal space;
determining, based on the integrated data, an intent associated with the event; and
determining an interaction to satisfy the intent.

18. The computer-readable storage medium of claim 17, wherein the input data indicates an immediate action, a behavior, or a verbal command provided by a user within the proximal space.

19. The computer-readable storage medium of claim 18, wherein the contextual data includes a geographical position of the user, a time-related factor, an environmental condition, or a presence of a person or an object.

20. The computer-readable storage medium of claim 19, wherein the intent is associated with the user procuring a good or a service from the vehicle, and the interaction includes actuating a subsystem of the vehicle to allow the user to procure the good or the service from the vehicle.
